(19) United States
(12) Patent Application Publication
(10) Pub. No.: US 2023/0302415 A1
(43) Pub. Date: Sep. 28, 2023

(54) MEMBRANES

(71) Applicant: THE UNIVERSITY OF MANCHESTER, Manchester (GB)

(72) Inventor: Sebastian LEAPER, Manchester (GB)

(21) Appl. No.: 18/021,888

(22) PCT Filed: Aug. 16, 2021
(86) PCT No.: PCT/GB2021/052123

§ 371 Date: Feb. 17, 2023

(30) Foreign Application Priority Data
Aug. 17, 2020 (GB) 2012818.7

(51) Int. Cl. B01D 69/14; B01D 67/00; B01D 71/34; B01D 71/82; C02F 1/44

(52) U.S. Cl. CPC B01D 69/148; B01D 67/00793; B01D 71/34; B01D 71/82; C02F 1/447; B01D 2323/36; B01D 2323/39; B01D 2323/2182; C02F 2103/06

(57) ABSTRACT

Described herein is a membrane for use in membrane distillation, comprising a porous polymer matrix and functionalized graphene or graphene oxide, the graphene or graphene oxide being functionalized with a polyhedral oligomeric silsesquioxane. The present membrane have improved separation performance.

### FIELD OF THE INVENTION

The present invention relates to membranes.

### BACKGROUND

Water scarcity is a growing problem globally. Currently around 2.7 billion people have poor access to clean water for at least one month a year. Increasing industrialisation, climate change and population growth are putting ever more stress on an already scarce resource. Between 1980 and 2010 alone, the global water demand increased by just over 40%. Along with improved water reuse and recycling, desalination is considered a necessary approach to increasing available supplies of fresh water. It can make various saline water supplies such as seawater or brackish water safe to drink and can also be used to remove harmful contaminants such as heavy metals from groundwater. Contamination in groundwater is a growing problem, threatening drinking water supplies in many parts of the world. For example, locations such as the Ganga River Basin, encompassing considerable parts of India, Bangladesh, Nepal, and Tibet¹; the Amazon Basin, including regions of Brazil and Peru² and the Datong Basin in North West China³ are but a few of the many areas that are experiencing dangerously high (>10 ppb⁴) levels of arsenic in the groundwater. Arsenic can exist in four valence states: −3, 0, +3 and +5, with inorganic As³⁺ and As⁵⁺ being the most common and relevant to groundwater contamination. Of these, As⁵⁺ (arsenate) is the most toxic to humans, with long term exposure increasing risks of skin, lung, bladder and kidney cancer as well as hypertension and cardiovascular disease amongst others. Ingesting large doses of inorganic arsenic results in gastrointestinal symptoms, disruptions to cardiovascular and nervous system functions, and eventually death⁵. There are a variety of both natural and man-made sources of arsenic in the environment and both must be monitored in order to mitigate risk to human health.

Various techniques for removing pollutants such as inorganic arsenic from groundwater exist, including oxidation, coagulation-flocculation, adsorption, ion exchange and membrane filtration. However, these can suffer from low separation efficiency or require complex multistep processes in order to operate effectively over time. Also, in the cases where the water supply is too saline to drink, only membrane filtration (by reverse osmosis) would be capable of achieving sufficiently high salt removal rates to render the water drinkable. Reverse osmosis however, requires significant electrical input (1-6 kWh m⁻³), requires extensive pre-treatment in order to operate, suffers from membrane fouling and produces large quantities of potentially harmful brine as a waste product.

Membrane distillation (MD) is a simple and robust technology for achieving very high removal rates of dissolved inorganic substances⁶. By utilising membranes to separate heated feed water from the permeate collection stream, membrane distillation allows the passage of vapour through the membrane whilst keeping all dissolved inorganic substances in the feed water⁷. This system is able to treat highly concentrated water because it operates on a gradient in vapour pressure rather than hydraulic pressure like reverse osmosis, and is therefore able to treat brines towards and even beyond saturation. This is an advantage in the case of arsenic removal since it can enable the complete recovery of water for zero liquid discharge applications⁸⁻⁹.

Much research effort has been put towards achieving higher production rates and lower propensity for pore wetting in MD in order for it to compete with other technologies¹⁰⁻¹¹. Designing high performance membranes is one of the main ways of achieving this.

Low membrane flux is one of the reasons why MD has struggled to compete with technologies such as reverse osmosis. Conventional membranes such as polytetrafluoroethylene (PTFE) or polypropylene (PP) require expensive processing techniques to produce a highly porous structure due to their poor solubility, meaning the costs can be high.

A more scalable process known as phase inversion allows rapid large scale membrane production directly from a homogeneous polymer solution; however, the performance of membranes made from this method can be limited by lower porosity or unfavourable pore structure.

Over the years, it seems that phase inversion has all but given way to electrospinning as the most effective way to fabricate MD membranes (although the cost-effectiveness and long-term performance stability has not yet been proven). By producing a network of randomly aligned polymer fibres, it is possible to obtain membranes with very high porosity and highly interconnected pores which have been applied to applications ranging from tissue engineering¹², energy storage¹³, air filtration¹⁴ and others¹⁵⁻¹⁷.

However, the membranes themselves still need to be improved in order to compete with other purification techniques.

Accordingly there remains a need for improved membrane distillation membranes.

The present invention has been devised in light of the above considerations.

### SUMMARY OF THE INVENTION

In a general aspect, the present inventors have found that adding a functionalised graphene or graphene oxide (including reduced graphene oxide), where the functionalisation is with a silsesquioxane, to the polymer of a membrane distillation membrane improves properties such as flux and filtration efficacy. The invention provides such membranes and methods for making them.

Accordingly, in a first aspect the invention provides a membrane for use in membrane distillation, comprising a porous polymer matrix and functionalized graphene or graphene oxide, the graphene or graphene oxide being functionalized with a polyhedral oligomeric silsesquioxane.

It may be preferable that the membrane comprises about 0.01 to 10 wt % of the functionalised graphene or graphene oxide. The content may be influenced by the method of manufacture. For example, the membrane may comprise 0.2 to 5 wt %, preferably about 0.5 to 3 wt % or about 1 to 3 wt %, more preferably about 2 wt %. These contents have been found particularly advantageous for electrospun membranes. On the other hand, the membrane may comprise about 0.01 to 2 wt %, preferably about 0.02 to 1 wt % or about 0.02 to 0.2 wt %, more preferably about 0.07 wt %. These contents have been found particularly advantageous for phase-inversion membranes.

The membrane may be one which is obtainable by a phase separation (phase inversion) method, electrospinning, solution blow spinning, electro-blow spinning or centrifugal spinning. Various types of phase inversion may be suitable. For example, nonsolvent induced phase inversion; vapour induced phase separation; thermally induced phase separation; evaporation controlled and combinations thereof. Such techniques are generally well known in the art.

The present invention therefore provides as a further aspect a method of manufacturing a membrane for membrane distillation, including the steps of (i) mixing the functionalised graphene or graphene oxide with the polymer in a solvent, to form a mixed solution; and (ii) facilitating the drying or precipitation of the mixed solution either by contacting the mixed solution with a polymer coagulation medium comprising a nonsolvent, in liquid or vapour form, by quenching the mixed solution, or by controlling the evaporation of the solvent, to effect a phase separation and precipitation of the mixed polymer/functionalized graphene or graphene oxide membrane. Membranes formed by such methods are also an aspect of the invention.

The invention also provides a method of manufacturing a membrane for membrane distillation, including the steps of (i) mixing the functionalised graphene or graphene oxide with the polymer in a solvent, to form a mixed solution; (ii) placing the mixed solution in a syringe; (iii) applying a voltage to the syringe to induce formation of a polymer jet out of the syringe; and (iv) collecting the polymer jet to form the membrane. Membranes formed by such methods are also an aspect of the invention.

A useful polymer to use in the present invention is polyvinylidene fluoride which allows facile and advantageous membrane formation. Other suitable polymers include polysulfone (PS), polyethersulfone (PES), cellulose acetate (CA), poly(vinylidene fluoride-co-hexafluoropropylene) (PVDF-co-HFP), polyethylene and polypropylene.

In the present invention, the polyhedral oligomeric silsesquioxane may preferably be represented by the following formula:

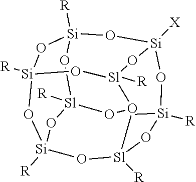

wherein each R and X is independently selected from H, alkyl, fluoroalkyl (that is, alkyl with at least one and preferably all H replaced with F), aryl, fluoroaryl (that is, aryl with at least one and preferably all H replaced with F), alkoxyl or fluoroalkoxyl (that is, alkoxyl with at least one and preferably all H replaced with F), and wherein at least one R or X group is not H and comprises a bond to the graphene or graphene oxide. For example, in some embodiments each R is (CH₂)(CH)(CH₃)₂ and X is (CH₂)₃NH—, where—represents the bond to the graphene or graphene oxide. In some embodiments each R is (CF₂)(CF)(CF₃)₂ and X is (CF₂)₃NH—, where—represents the bond to the graphene or graphene oxide.

Suitably, membranes according to the present invention have a porosity of 60 to 95%. This gives a good flux and filtration effect while retaining structural strength. The inclusion of functionalised graphene or graphene oxide permits a higher strength membrane to be formed.

A further aspect of the present invention relates to a membrane distillation module, comprising a permeate side conduit; a feed side conduit; and a membrane as described herein between the permeate side conduit and the feed side conduit.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a schematic of a membrane fabrication method via nonsolvent-induced phase separation.

FIG. 2 shows a schematic of an electrospinning fabrication method.

FIG. 3 shows a schematic of the membrane distillation testing system.

FIG. 4 shows surface SEM images of a) PVDF/LiCl, b) PVDF/LiCl/GPOSS, c) Commercial PTFE, and d) Commercial PVDF membranes.

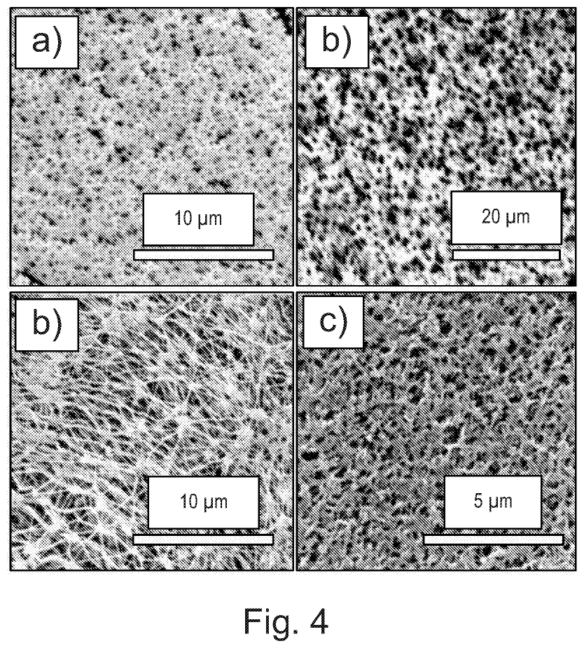

FIG. 5 shows a) nitrogen permeability, b) and surface porosity of a membrane of the present invention compared to control and commercial membranes.

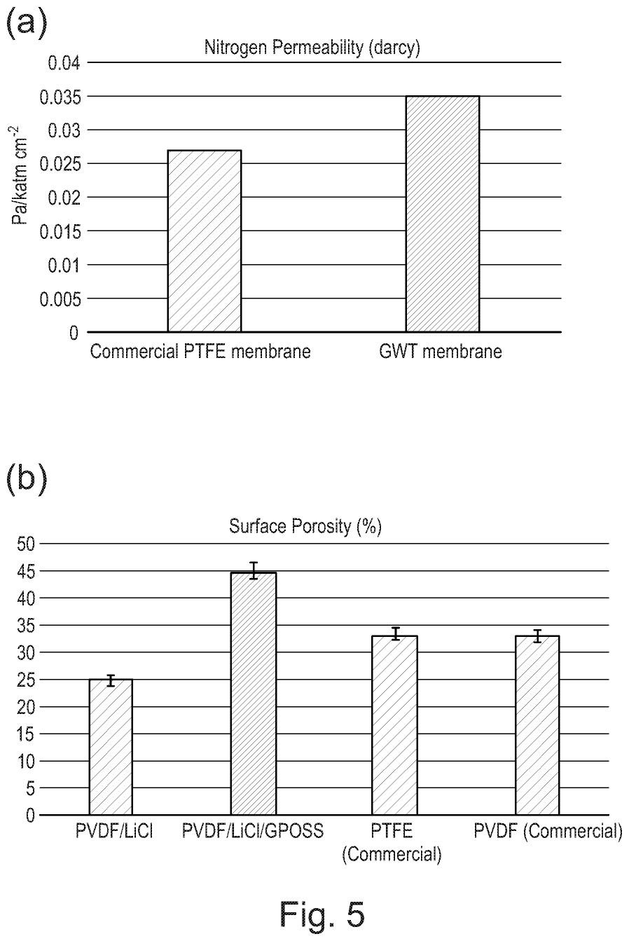

FIG. 6 shows the flux performance of a membrane according to the present invention (fabricated by phase inversion) as compared to a commercial PTFE membrane.

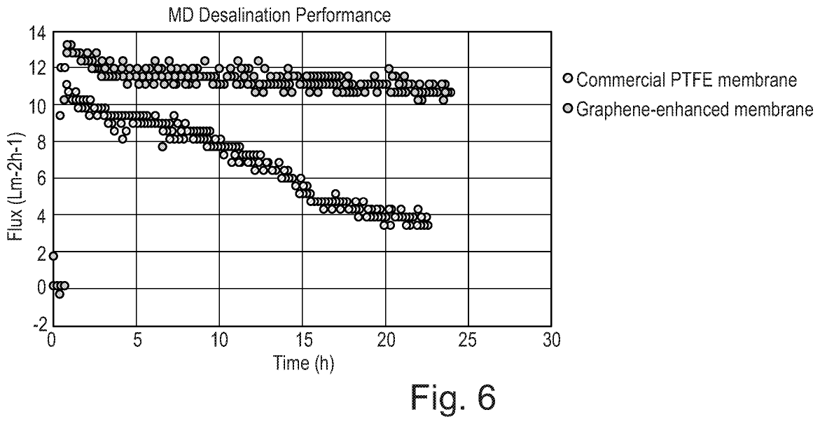

FIG. 7 shows scanning electron microscope images of a commercial PTFE membrane (Reference Example 1, top), an unmodified electrospun PVDF membrane (Comparative Example 1, middle) and a modified electrospun membrane according to the present invention containing 3 wt. % POSS-rGO (GP 3, that is, Example 4, bottom). The right hand column shows the same membranes after 24 hours of testing in MD and inset images in the top right corners are the same membranes taken at lower magnification. For the PTFE images, the magnification is 12000× and 6000× (inset) with scale bars representing 5 and 20 μm, respectively. For the PVDF and GP 3 (Example 4) membranes the magnification is 3000× and 800× (inset) with scale bars representing 10 and 50 μm, respectively. Inset images in the bottom left corners of the PVDF and GP 3 micrographs are photographs of the membranes cut into disks 2 cm in diameter and placed on the same white background.

FIG. 8 shows scanning electron microscope images of electrospun membranes of the present invention before (a series) and after (b series) membrane distillation experiments. The numbers correspond to the membranes as follows: I) commercial PTFE, Reference Example 1; II) pure PVDF electrospun membrane, Comparative Example 1; III) GP 0.5, Example 1; IV) GP 1, Example 2; V) GP 2, Example 3 and VI) GP 3, Example 4. The scale bar on the large images represent 5 μm for PTFE (1 a & b) and 20 μm for other membranes and their magnifications are 12000× and 3000×, respectively. The inset images are at lower magnifications—6000× for PTFE and 800× for the other membranes and the scale bars represent 10 and 50 μm, respectively. Inset photographs in I(a) and VI(a) indicate the colour difference between the PVDF (Comparative Example 1) and GP 3 (Example 4) membranes, cut to a diameter of 2 cm.

FIG. 9 shows scanning electron micrographs with X-ray dispersive spectroscopy maps and spectra for the PVDF (Comparative Example 1) and GP 2 (Example 3) electrospun membranes and the commercial PTFE membrane (Reference Example 1) taken after the inorganic fouling tests. A pronounced Si peak in the GP 2 (Example 3) image corresponds to the POSS-rGO. This can be seen in the clusters on the surface of the graphene flakes highlighted by the dashed circles. The scale bars represent 10 μm.

FIG. 10 shows morphological, mechanical and wetting properties of electrospun membranes according to the present invention including their pore size distributions (FIG. 10(a)); ultimate tensile strength and Young's modulus (FIG. 10(b)); and the water contact angle and liquid entry pressures (FIG. 10(c)). Error bars represent standard deviations from three samples (or five in the case of water contact angle).

FIG. 11 shows the flux (FIG. 11(a)), permeate conductivity (FIG. 11(b)) data for the electrospun membranes and the commercial PTFE membrane where error bars represent the standard deviation from three different membranes. Inset in FIG. 11(b) is flux and permeate conductivity data for the 5 day continuous MD experiment using membrane Example 4 (GP 2). FIGS. 11(c-e) are normalised flux and permeate conductivity values from 24 hour MD experiments using the feed solution with added calcium carbonate (10 mg L-1) and iron sulphate heptahydrate (2 g L-1) as foulants. Inset in FIG. 11(d) is a photograph of the feed solution and the permeate solution from the Example 4 (GP 2) membrane, showing the removal of colour.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

The inventor has found that inclusion of graphene oxide functionalised with certain nanoparticles, in a polymer solution then forming a membrane leads to membranes with advantageous membrane distillation properties. Described below are particular examples of the fabrication and testing of such membranes.

By suitable control of factors such as functionalization, functionalised graphene or graphene oxide content, and use of pore formers, membranes with desirable flux and salt rejection characteristics can be formed.

Graphene

Graphene as a material is generally well known in the materials science community; however, some discussion for completeness is provided here.

Graphene exists in both monolayer and few layer forms.

The term graphene oxide is generally used to refer to both monolayer graphene and few layer graphene which has been (or at least is) oxidised such that its surface is decorated with oxygen-containing groups such as ketones, carboxylic acids and epoxides. In the present application, the term “graphene” (and thereby graphene oxide) is used to describe materials consisting of ideally one to ten graphene (or graphene oxide) layers, preferably where the distribution of the number of layers in the product is controlled.

The graphene used in the present invention is not particularly limited; it may preferably comprise single layer graphene (or graphene oxide) flakes; its method of manufacture is not limited. The CIO atomic ratio in graphene oxide is typically in the range 1.5-2.5, for example about 2.0.

Graphene or graphene oxide flake size is not particularly limited, however it may suitably be around 1 μm. However flakes up to around 20 μm in size may also be suitable.

The graphene references herein may suitably be graphene oxide. That is, the functionalised graphene or graphene oxide may suitably be a functionalised graphene oxide.

Functionalisation

The graphene or graphene oxide described herein is functionalized with nanoparticles of a silsesquioxanes. Functionalisation of graphene and graphene oxide, and techniques for it, are well known in the art.

In general, a functionalizing compound A-YX is reacted with graphene oxide to form the A-graphene oxide bond. Herein, for simplicity, A is referred to as both a functionalizing compounds and group. It will be understood that A-Y, where X is hydrogen (H) is commonly used. For example, A may comprise an amino group or silane group, from which H is ‘removed’ in reaction with graphene oxide to form a bond to the graphene oxide flake. For example a condensation reaction may occur between a carboxylic acid functional group on the graphene oxide surface and the A-Y compound.

Such reactions may broadly be described as being R¹—NH₂+[graphene oxide]->R¹—NH-[graphene oxide], or R¹—SiH₃+[graphene oxide]->R¹—SiH₂-[graphene oxide].

The product may then optionally be further reduced to provide a functionalised graphene, as in R¹—NH-[graphene] or R¹—SiH₂-[graphene].

In the present invention A-Y is a silsesquioxane. Silsesquioxanes have the general formula [RSiO_{3/2}]ₙ, wherein R is, for example, H or substituted or unsubstituted alkyl (for example unsubstituted C₁₋₈ alkyl), aryl (for example phenyl) or alkoxyl (for example O—C₁₋₈ alkyl). These commonly and preferably have polyhedral structures, for example as illustrated below (a polyhedral oligomeric silsesquioxane, POSS):

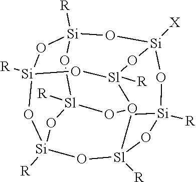

Here, R and X may be, for example, independently selected from H, alkyl (for example unsubstituted C₁₋₈ alkyl), aryl (for example phenyl) or alkoxyl (for example O—C₁₋₈ alkyl). They might also be of the silyl ether type (for example O—Si (C₁₋₈ alkyl)₂-C₁₋₈ alkyl).

These alkyl, aryl, alkoxyl or silyl ether groups may be substituted with one or more F groups or OH groups. For example, they may be fluoroalkyl (that is, alkyl with at least one and preferably all H replaced with F), fluoroaryl (that is, aryl with at least one and preferably all H replaced with F), or fluoroalkoxyl (that is, alkoxyl with at least one and preferably all H replaced with F). They may be fluorosilyl ether (that is, silyl ether with at least one and preferably all H replaced with F).

Commonly, one of these R and X may comprise an amino (—NH—), silane (—SiH—) or hydroxyl (—OH) group to facilitate functionalization as explained above.

In the functionalised graphene or graphene oxide, one of the R and X groups is not H and is connected to the graphene or graphene oxide (which itself may be reduced as described herein). By connected to the graphene or graphene oxide, we mean that said R or X group comprises a bond to the graphene or graphene oxide; that bond may be part of a larger group. For example, if the linking group is X, it may be (CH₂)₁₋₈—, or (CH₂)₁₋₈NH—, (CH₂)₁₋₈SiH—, or (CH₂)₁₋₈O—, in the functionalised graphene or graphene oxide. In each instance one or more H may be replaced with F, for example to give X as (CF₂)₁₋₈—, (CF₂)₁₋₈NH—, (CF₂)₁₋₈ SiH—, or (CF₂)₁₋₈O—. Alternatively, a corner Si—R or Si—X may act as the silane linker to the graphene or graphene oxide; in such cases, the corner Si group may end up being the point of attachment to the graphene or graphene oxide.

It is thought that, without wanting to be bound to the theory, the protruding silica nanoparticle in the molecule adds a degree of surface roughness which conventional functional groups don't provide, which can increase the degree of hydrophobicity and surface porosity of the membrane.

In preferred embodiments, the silsesquioxane may be one in which each R is (CH₂)CH(CH₃)₂ (that is, isobutyl) and X is (CH₂)₃NH₂ (that is, aminopropyl). The linkage to the graphene or graphene oxide is therefore via the X group, as (CH₂)₃NH—. In other embodiments, the silesquioxane may be one in which each R are and X is O—Si(CH₃)₂—(CH₂)₂—C(CH₃)₂—OH. The linkage to the graphene or graphene oxide is via the X group, as O—Si(CH₃)₂—(CH₂)₂—C(CH₃)₂—O—.

In some embodiments the R group is preferably a fluorocarbon (a fluroalkyl, fluoroaryl or fluoroalkoxyl as described above, for example), this can produce a highly hydrophobic material.

Where the R group is alkyl or fluoroalkyl, it may be branched or straight chain. For example, branched or linear C₁₋₉ alkyl or branched or linear C₁₋₈ fluoroalkyl. Branched may be preferred to increase the hydrophobicity.

R and or X may be optionally substituted with further hydrophilic groups such as —OH.

Suitable methods for these functionalisation reactions are known in the art. For example, an amino functionalised POSS can be reacted with graphene oxide with N,N′-Dicyclohexylcarbodiimide (DCC). This forms the functionalised graphene oxide (fGO).

The functionalised graphene oxide may be further treated, for example heat treated to further reduce the oxygen-containing groups of the fGO. This leads to a functionalised reduced graphene oxide (frGO) or functionalised graphene (fG)—the reduction may be complete or partial depending on the heat treatment. In the examples above where a POSS is used for functionalisation, then, the product may be referred to as POSS-rGO or POSS-G.

For completeness it is clarified that references herein to fGO might equally apply to frGO or fG.

Phase Inversion

One suitable technique for forming the membranes of the present invention is phase inversion. Formation of membranes by phase inversion is a well-known and previously used technique. In general, a liquid membrane precursor solution containing the materials to form the membrane along with a solvent is in some way treated in order to remove the solvent and thus form the membrane. The membrane is commonly, but not always, formed upon a supporting substrate.

In general, in a first step the functionalised graphene or graphene oxide is mixed with a polymer in a solvent, to form a mixed solution. In a second step, the drying or precipitation of the mixed solution is facilitated, which effects a phase separation and forms the mixed polymer/functionalized graphene or graphene oxide membrane. The facilitation in the second step may be done in various ways. For example it may be done by contacting the mixed solution with a nonsolvent of the polymer/functionalised graphene or graphene oxide combination. The nonsolvent may be a vapour or a liquid. It may be done by heating the mixed solution. It may be done by otherwise evaporating the solvent, for example by changing the pressure conditions. In other such methods, the membrane film may be left in ambient conditions to allow some or all of the solvent to naturally evaporate away. In some thermal processes, in the first step the functionalised graphene or graphene oxide is mixed with a melted polymer rather than being dissolved in a solvent; then in the second step the membrane is solidified by controlling the temperature thereafter (the films may be quenched, for example).

An example method is nonsolvent-induced phase inversion/separation.

The method may for example include steps of (i) mixing the functionalised graphene or graphene oxide with the polymer in a solvent, to form a mixed solution; and (ii) contacting the mixed solution with a polymer coagulation medium comprising a nonsolvent, to effect a phase separation and precipitation of the mixed polymer/functionalized graphene or graphene oxide membrane. The present invention provides such a method.

The mixed solution may contain the polymer and functionalised graphene or graphene oxide in a ratio appropriate for the final product. For example, as an amount relative to the combined functionalised graphene or graphene oxide+polymer content (that is, without the solvent), the mixed solution may contain about 0.01 to 2 wt %, preferably about 0.02 to 1 wt % or about 0.02 to 0.2 wt %, more preferably about 0.07 wt %.

It may be preferred the functionalized graphene or graphene oxide and polymer (which will form the polymer matrix) are mixed together before the phase inversion/precipitation step. In this way the functionalized graphene or graphene oxide is properly dispersed.

It is thought that the complex interactions between the functionalised graphene or graphene oxide, the polymer solution and the polymer coagulation medium gives rise to a more open porous structure in the final membrane than for control systems.

In some embodiments the polymer coagulation medium consists only of (i.e. is) one or more nonsolvents for the polymer and functionalised graphene or graphene oxide. In some embodiments the nonsolvent comprises or is water. This is of course readily available and non-toxic.

Step (ii) may be achieved by immersion of the mixed solution in a nonsolvent bath. There may be an intervening step (ia) of applying the mixed solution to a support which is then immersed in the nonsolvent. On the other hand, the support may be placed in the nonsolvent first, and the mixed solution then added. It can then fall onto the support for precipitation.

Alternatively or additionally, there may be an intervening step (ib) (after (i) and before (ii)) of pushing the mixed solution through a spinneret to form a hollow cylinder entering the coagulation medium. This technique can form hollow fibres.

In some embodiments the support of membrane may be removed from the nonsolvent. Alternatively the nonsolvent may be removed, for example by draining.

A continuous process can be envisaged where the mixed solution is applied to a substrate fed from a first roller; the substrate is then moved through a nonsolvent bath to form the membrane and removed from the nonsolvent on a second roller. Such a method gives advantageous processing and manufacturing speed.

The solvent removal may be conducted in a variety of different ways. For example, the solution temperature may be reduced to encourage precipitation of the membrane; or the solution may be heated or otherwise treated to evaporate the solvent. The precursor solution (or substrate supporting it) may be immersed in a nonsolvent (or ‘antisolvent’) in which the membrane materials are not soluble. By solvent exchange the solvent in the solution is drawn into the nonsolvent and the membrane drops out of solution (it cannot dissolve in the nonsolvent) to form the membrane. This may be referred to as nonsolvent-induced phase separation.

The container of the nonsolvent is often called a coagulation bath or solution.

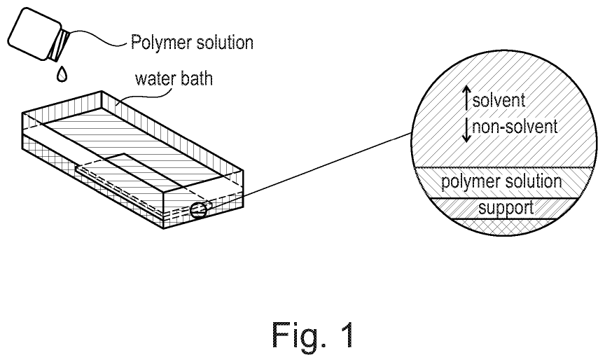

In the present invention a suitable nonsolvent is water, although various other nonsolvents, including both single component and multi-component nonsolvents, can be envisaged. An example arrangement is illustrated in FIG. 1. There addition of the polymer (and functionalised graphene or graphene oxide) solution 1 to the water bath 2 is shown, along with a schematic of the movement of solvent 3 and nonsolvent 4 in the vicinity of the polymer solution 1 on its support 5.

As the solvent exchange/solvent removal occurs, pores in the membrane can form as precipitation occurs and nonsolvent is ‘trapped’ to be removed later.

As explained herein, the present invention is directed to membranes which may be made by phase inversion techniques, in particular nonsolvent-induced phase separation. With the present inclusion of functionalized graphene or graphene oxide, advantageous membranes and pore structures can be obtained.

It is believed that by including the functionalised graphene or graphene oxide in the precursor solution leads to the formation of a mixed matrix, that is, a porous polymer matrix with functionalized graphene or graphene oxide dispersed within the polymeric matrix. This is different from a structure obtained by, for example, coating or applying a functionalised graphene or graphene oxide onto a polymer.

Electrospinning

Another suitable method for forming the membranes of the present invention is electrospinning. Again, formation of membranes by this technique is generally well known in the art.

In general, a polymer solution (dope solution) is drawn into a dispenser such as a syringe which is attached to a pump. The dispenser is also attached to a high voltage supply. By application of a voltage to the dispenser, the polymer solution is sprayed out of the dispenser, towards a collection plate. The polymer jet may cool and dries in flight, depositing at the collection plate as a fiber.

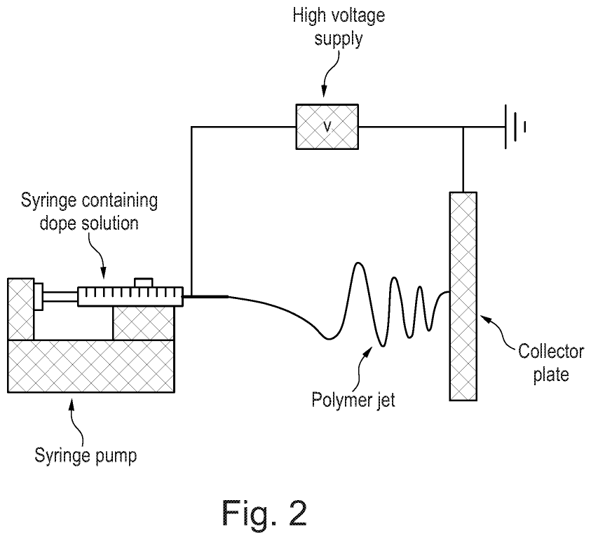

An example arrangement is illustrated in FIG. 2. There a syringe 6 holds the polymer solution 7 within; it is mounted on a syringe pump 8. It is connected to a high voltage supply 9. By application of a voltage a polymer jet 10 is ejected, and deposited on the collection plate 11.

The dope solution can contain the desired amount of functionalised graphene or graphene oxide for the intended product. For example, as described herein, a content of 0.2-5 wt %, preferably 0.5-3 wt %, and most preferably about 2 wt % is used.

As explained herein, the present invention is directed to membranes which may be made by electrospinning techniques. The present invention also provides methods for making membranes including electrospinning a polymer solution comprising a polymer and the functionalised graphene or graphene oxide described herein.

Other suitable manufacturing techniques include solution blow spinning, electro-blow spinning and centrifugal spinning, all of which are well known in the art.

Membrane

The polymeric matrix in the present membranes is not particularly limited; the present invention can enhance the performance of membranes of many different materials. Suitable example polymer materials include but are not limited to polytetrafluoroethylene, polypropylene, polyvinylidene fluoride, polyvinylidene difluoride, polysulfone, polyether sulfone, polyacrylonitrile, polyethylene and polyvinylchloride. Of these, polyvinylidene fluoride provides a convenient and low cost option.

The functionalized graphene or graphene oxide improves the mechanical strength of the polymer matrix and therefore the membrane itself. This is advantageous; furthermore, it means that for a given mechanical strength increased porosity can be utilised effectively, for example.

Membranes of the present invention may have advantageous surface porosities. Such porosity structures improve the flux and general performance obtained from the membranes.

In the present invention, membranes of enhanced porosity can be produced. For example, the membranes of the present invention may have a porosity of 60 to 95%. For electrospun membranes, the porosity may suitably be 85% or more, suitably 85-95%, more suitably 87-92%. For phase inversion membranes, the porosity may suitably be 70-80%.

In some embodiments, particularly those where phase inversion manufacturing is used, the membranes of the present invention may include pore formers. Use of pore forming materials is well known in membrane formation technology; suitable pore formers include, for example, polyvinylpyrrolidone, polyethylene glycol, pluronic (poloxamer) block copolymers, tetronic (poloxamine) block copolymers, water, and LiCl.

In some embodiments, for example where a block copolymer is used as the pore former, it remains in the membrane after formation. In other embodiments, such as when the pore former is LiCl, it is removed after or while the membrane is formed. Accordingly the present invention may include a separate step of removing the pore former. For example, there may be a step of storing the membrane in water or the nonsolvent solution to provide time for the pore formers to diffuse or otherwise leach out of the membrane into the solution/water.

In the present invention, a particularly suitable pore former is LiCl. It has been found that this pore former has surprisingly advantageous effects when used with the functionalized graphene or graphene oxide described herein. In particular, use of LiCl as a pore former can give increased pore uniformity. It is believed that this is due to LiCl increasing the exchange rate between solvent and nonsolvent during phase separation.

In the membranes, it will be apparent that various contents of the presently describes functionalised graphene or graphene oxide may be included (as mentioned above, and applicable throughout, the following also applies to functionalised reduced graphene oxide).

The present inventors have found that in some embodiments 0.01 to 10 wt % of the functionalised graphene or graphene oxide may be included. The content may be influenced by the method of manufacture. For example, the membrane may comprise 0.2 to 5 wt %, preferably about 0.5 to 3 wt % or about 1 to 3 wt %, more preferably about 2 wt %. These contents have been found particularly advantageous for electrospun membranes. On the other hand, the membrane may comprise about 0.01 to 2 wt %, preferably about 0.02 to 1 wt % or about 0.02 to 0.2 wt %, more preferably about 0.07 wt %. These contents have been found particularly advantageous for phase-inversion membranes.

These preferences apply particularly where the polymer included in the membrane is polyvinylidene fluoride, but are applicable broadly.

Membrane Distillation

The present membranes may be applicable in known membrane distillation modules and apparatuses. The present invention therefore also provides a membrane distillation module comprising a membrane according to the present invention; and a membrane distillation apparatus comprising such a module. In membrane distillation the membrane is non-wetted.

For example, the present invention may provide a membrane distillation module, comprising a permeate side conduit; a feed side conduit; and a membrane as described herein between the permeate side conduit and the feed side conduit. Depending on the type of module there may be further parts. For example there may be an air gap and condenser plate, the condenser plate adjacent to the permeate side conduit and the air gap being between the membrane and the condenser plate.

Membrane distillation (MD) is a separation process where a membrane separates, directly or indirectly, a solution which is to be purified (that is, a ‘feed’) from a further fluid (the permeate side fluid). The two solutions may be at different temperatures; for example, the solution to be purified is at a higher temperature than the other fluid. Thus the solution to be purified may be a ‘hot’ solution and the other fluid a ‘cold’ fluid, or a coolant. Alternatively or additionally the two solutions may have different solute concentrations. In each case there is a vapour pressure gradient across the membrane which drives vapour from the high pressure to the low pressure side.

By providing a membrane as in the present invention, the membrane prevents mass transfer of the liquid, and therefore a gas-liquid interface is created. A temperature gradient on the membrane can result in a vapour pressure difference, whereby volatile components in the supply (feed) mix evaporate through the pores of the membrane and, via diffusion and/or convection of the compartment with high vapour pressure, are transported to the compartment with low vapour pressure where they are condensed in the cold liquid/vapour phase.

So, taking for example salt water, a hot supply solution (feed) of salt water is passed through the MD module and water vapour is transported through the membrane. Thus ‘unsalted’ (purified) water is obtained on the distillation-side (as the permeate) and a more concentrated salt water solution remains on the hot supply (feed) side.

The manner in which the vapour pressure difference is generated across the membrane is determined by the specific module configuration. Various configurations are known, for example direct contact membrane distillation (DCMD) wherein the permeate-side consists of a condensation liquid (often clean water) that is in direct contact with the membrane; air gap membrane distillation (AGMD) wherein the evaporated solvent is collected on a condensation surface that is separated from the membrane via an air gap; vacuum membrane distillation (VMD) which is similar to AGMD except that instead of a coolant/permeate side fluid, air gap and condensation plate, the ‘cold fluid’ (permeate side fluid) is merely a vacuum; sweep gas membrane distillation (SGMD) which is similar to VMD except that a sweep gas is used instead of a vacuum; and osmotic distillation wherein there is a concentration difference of components between the feed side and permeate side fluids, resulting in permeation of vapour from the side with the lower concentration to the side with the higher concentration through the membrane. In SGMD and VMD, condensation of vapour molecules may take place outside the membrane-containing MD module.

In some instances, the air gap can be filled either with a liquid, such as permeate (referred to as liquid/permeate gap MD—L/PGMD) or a porous solid material of some kind (referred to as material gap MD (MGMD). In addition, a sweep gas may be used to collect the vapour (SGMD) and combinations of the abovementioned configurations are possible, in particular, Vacuum-air gap (V-AGMD).

In the present invention, a membrane distillation module may comprise a supply conduit for the water to be purified (the feed), separated from a conduit for the purified water (permeate) by a membrane of the present invention. The conduit for the permeate may then itself be separated from a further conduit, for example for a coolant, by a condensation plate.

In a membrane distillation apparatus, the supply conduit may have an inlet connected to a reservoir of water to be purified and an outlet connected either to that reservoir (for recirculation) or to a collection vessel. The permeate conduit may be connected to a collection vessel for collection of the permeate or to a condenser in which the permeate is condensed to liquid form.

Where the present invention is applied to air gap membrane distillation, in more detail, a membrane distillation module may comprise for example a permeate side (cold feed) conduit; a condenser plate adjacent to the permeate side (cold feed) conduit; a permeate conduit adjacent to the permeate side (cold feed) conduit; a membrane according to the present invention adjacent to the permeate conduit; and a feed side (hot feed) conduit adjacent to the membrane. That is, the permeate side (cold feed) conduit is separated from the permeate conduit (air gap) by the condenser plate; and the permeate conduit is separated from the feed side (hot feed) conduit by the present membrane. The feed side (hot feed) conduit may have an inlet connected to a supply of water to be purified and an outlet connected to a collection vessel or to the supply of water to be purified; the permeate side (cold feed) conduit may have an inlet connected to a coolant supply and an outlet connected to that supply for recirculation of coolant. The permeate conduit may be connected to a collection vessel, into which the purified water condensed within the module on the condensation plate can drain.

The membranes themselves may be provided in various forms depending on the module configuration and final application. For example, the membrane may be formed as a flat sheet or plate-like structure; or with a tubular or hollow fibre morphology. Flat sheet or plate-like membranes may be used in plate-and-frame membrane modules or spiral wound modules, for example.

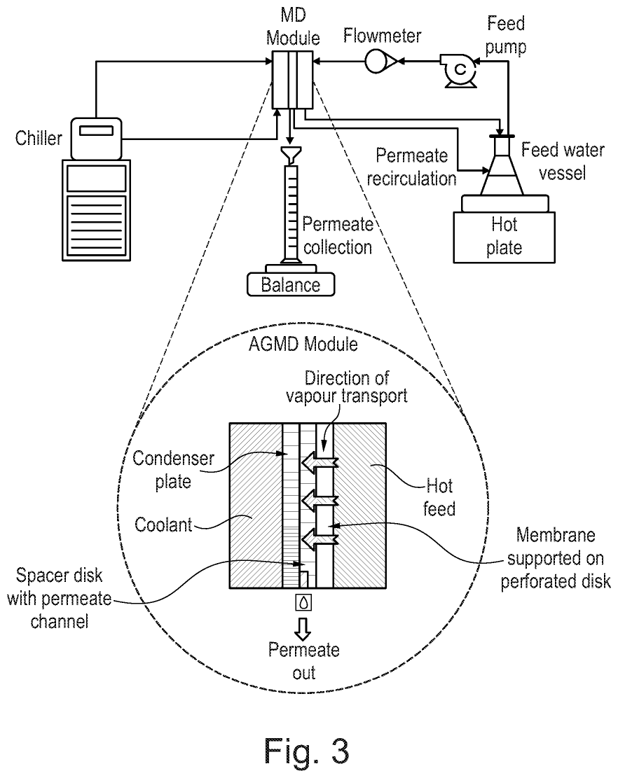

An example apparatus, for testing the permeate, is illustrated in FIG. 3. The detailed schematic of the AGMD module 15 is shown to assist with the above explanation. It can be seen that the membrane 20 may be mounted on a perforated plate or disk 21 to provide enhanced structural integrity. In some modules, flexible spacers and supports are used to mount the membrane. The spacer disk 22 between the membrane 20 and the condensation plate 23 forms a permeate channel or conduit. It can also be seen that the coolant 24 in this arrangement is recirculated. The hot supply of water 25 to be purified (feed water) is provided by heating a vessel 26 via a hot plate 27 (of course other methods of heating are possible); a feed pump 28 supplies the feed water to the module. After passing through the module, the now more concentrated solution is recirculated to the feed water supply. Coolant 24 is circulated on the cold side by a chiller 29.

The permeate may be collected for analysis; in this example, that is done via a collection vessel 30 on a balance 31.

It will be recognised that, where salt (NaCl) is present in the water to be purified, the conductivity of the permeate can be indicative of how much salt has been successfully ‘removed’ by the membrane. A lower conductivity is indicative of a lower salt content and therefore a higher membrane performance.

The membranes of present invention may be used to remove a variety of pollutants from water. For example, use of the present membranes in membrane distillation to remove arsenic from water is envisaged.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### EXAMPLES

Materials

For the functionalisation reaction, GO (1 wt. % aqueous suspension) was purchased from William Blythe (Lancashire, UK), aminopropyllsobutyl polyhedral oligomeric silesquioxane (AM0265—referred to here as POSS) was purchased in powder form from Hybrid Plastics (US), N,N′-Dicyclohexylcarbodiimide (DCC) and tetrahydrofuran (THF) were purchased from Sigma Aldrich (Germany). Electrospinning solutions were prepared using polyvinylidene difluoride (PVDF−Mw=534,000 g mol⁻¹) and N,N dimethylformamide (DMF)—both purchased from Sigma Aldrich, Germany as well as acetone (Fisher Scientific, UK). Millipore deionized (DI) water (18 MΩcm resistivity) was used for the preparation of feed solutions along with sodium arsenate dibasic heptahydrate and sodium meta arsenite, which were purchased from Sigma Aldrich. NaCl, CaCO₃ and FeSO₄·7H₂O also used for the feed solutions were purchased from Acros, Belgium. All reagents and materials were used as received.

Graphene Oxide Functionalisation

Functionalisation of GO with POSS occurred via amide formation, following the same method described elsewhere²¹. Briefly, 100 mg of GO was freeze dried from an aqueous suspension using liquid nitrogen. The dried GO was then re-dispersed in 50 mL of THF in a sonication bath (Elmasonic, 80 kHz frequency at 100% power) for 2 h. This was then decanted into a 250 mL round bottom flask along with 2 g POSS and 100 mg of DCC. This mixture was sonicated for a further 10 min and then refluxed at 80° C. for 48 h. Following this, the remaining solvent was evaporated and the powder was heat treated at 120° C. for 8 h to partially reduce the GO. The powder was then re-dispersed in 50 mL of THF, poured into approximately 500 mL of methanol and then filtered using a homemade polyacrylonitrile filter (0.2 μm pore size). This last step was repeated three times to remove any unreacted POSS and the powder (POSS-rGO) was then placed in a vacuum oven at 80° C. and then stored for further use.

Fabrication of Electrospinning Solutions

The electrospinning polymer solutions were prepared by dissolving 1.4 g of PVDF powder in 8.6 g of a DMF/acetone mixture with ratio of 1:2, making solutions with a total weight of 10 g in each case. This solvent mixture contained various quantities of POSS-rGO as described in Table 1 below (see section “Results”). This was done by first producing a 20 mg mL⁻¹ solution of POSS-rGO in DMF via sonication, followed by the addition of acetone and a final step of stirring over night at 40° C. until the polymer had completely dissolved.

Fabrication of Electrospun Membranes

Electrospun membranes were prepared using a setup that consisted of a syringe pump (Cole Parmer), a high voltage supply and a stainless steel tray which was used as a collector. Prior to spinning, the dope solutions were individually drawn into a 10 mL plastic syringe (BD Emerald) which was left standing on end for a few minutes to allow any bubbles to escape. Then 19G 1.1×50 mm needle (BD Microbalance) whose sharp end had been flattened by abrading it with sand paper, was fixed to the syringe. This was then clamped onto the syringe pump and the needle was connected to the high voltage supply using a crocodile clip. The collector plate with an area of 552 cm² was connected to the opposite terminal of the high voltage supply, again using a crocodile clip and was placed 20 cm from the tip of the needle.

Once the syringe needle and collectors were connected, the program on the syringe pump was run, and the high voltage supply was switched on. The voltage and dope solution flow rate were kept constant for each dope solution at 18 kV and 5 mL h⁻¹, respectively.

After the dope solution had been deposited, the membrane was left to dry overnight under a fume hood. The membrane was then carefully peeled off the collector plate and placed flat on a 250×230 mm sheet of tempered glass. An identical piece of glass weighing 785.2 g was placed on top of the membrane, exerting a pressure 13.94 Nm⁻². This was then placed in an oven at 170° C., just below the melting temperature of PVDF, for 1 h in order to compact the fibres and increase the mechanical stability of the membrane. After this post-treatment, the membrane was removed and stored for further use.

Characterization of Electrospun Membranes

Scanning Electron Microscopy

The membranes were imaged using scanning electron microscopy (SEM) (QUANTA FEI 200, USA) with a 15 kV acceleration voltage and a 2.5 mm spot size. To prepare the samples, small pieces of each membrane were stuck onto SEM holders using carbon tape and were sputtered with gold (or platinum for the fouled membranes) with a layer thickness of 5-6 nm to render the samples electrically conductive.

Energy-Dispersive X-Ray Spectroscopy

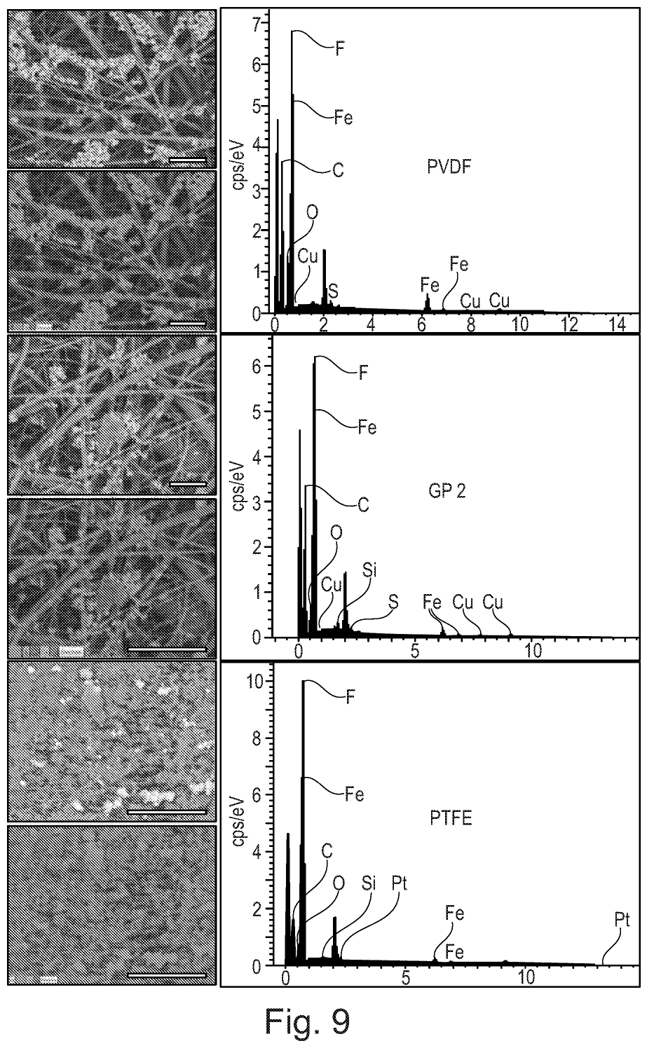

In conjunction with SEM imaging, elemental analysis of the membranes was performed with EDX spectroscopy. This was used to analyze the components from the inorganic fouling experiments and spectra were collected using an Oxford Instruments X-Max detector and plotted using Aztec 3.3 SP1software. Results are shown in FIG. 9.

Tensile Testing

The mechanical properties of the membranes were investigated by tensile testing. Measurements were carried out using an Instron 5542 tensiometer (Instron, USA) with a 100 N load cell under ambient conditions. Samples were prepared by cutting rectangular strips of membranes (7 mm×60 mm) and sandwiching each end between two 10 mm squares of thin cardboard using double-sided sticky tape. The effective length of each sample was 40 mm, giving a length-width ratio of 5.71:1. Three identical samples were prepared for each membrane. The thickness of the membranes was measured with the digital micrometer screw gauge in proximity to where the tensile strips were cut. The tensile strips themselves were not measured as the compression from the micrometer may have affected the mechanical properties or induced a defect. Ten thickness measurements were taken for each membrane and averaged. The elongation rate was set up to 10 mm min⁻¹ and ultimate tensile strength and Young's modulus values were calculated.

Capillary Flow Porometry

The pore size distributions and N₂ permeability of the electrospun membranes were measured by capillary flow porometry (Porolux™ 1000, POROMETER, Belgium). This employed the gas-liquid displacement method using perfluoropolyether (Porefil 125, surface tension=15.88±0.03 mN m⁻¹) as the wetting liquid as detailed in previous work³⁷. The slope of the dry curve was used to calculate the nitrogen permeability by dividing by the membrane thickness. This technique was also used to measure the liquid entry pressure (LEP) of the membranes. Using a non-standard method, 13 mm disks were cut from each membrane and inserted dry into the Porolux device. Then, 0.3 mL of DI water was dropped onto the surface of the membrane and the compartment was closed by connecting the gas. The Porolux was set to provide a maximum pressure of 1 bar over 50 steps and the ‘full porometry’ program was executed. This gradually increased the pressure on the water sat atop the membrane. As the pressure continued to rise, a sudden increase in gas flow was measured by the device, indicating that the water had been forced through the membrane. The pressure at which this occurred was reported as the LEP. For all measurements, the reported values are averages of three samples taken from different areas on the membrane.

Porosity

Membrane porosity, c, was evaluated using the gravimetric method, as reported previously^{20, 54}. Briefly, 10 mm squares were cut out of the membranes (3 for each membrane) and weighed. Then these squares were immersed in the same liquid used for porometry (Porefil 125) for 30 seconds to become fully wetted. One by one, the squares were removed from the wetting liquid and placed on tissue paper and were gently daubed, removing any residue from the surfaces. The samples were then weighed again in order to determine the mass of wetting liquid which had been adsorbed by the pores. The membrane porosity was then calculated using:

$$ε = \frac{\frac{{W}_{w} - {W}_{d}}{{ρ}_{w}}}{\frac{{W}_{w} - {W}_{d}}{{ρ}_{w}} + \frac{{W}_{d}}{{ρ}_{p}}} \times 100 \qquad Equation 1$$

where W_{w} is the wet membrane weight and W_{d} is the dry membrane weight. The densities of Porefil 125 (ρ_{w}) and the PVDF polymer (ρₚ) are 1.9 and 1.78 g cm⁻³, respectively. The values reported were the averages of three measurements.

Water Contact Angle

The wetting properties of the membranes were evaluated using water contact angle (CA) measurements as described previously³⁸. Membrane strips were fixed to glass slides which were then placed on the stage of an Attension Theta optical tensiometer and five drops were measured for each membrane and averaged.

Water Quality Analysis

The quality of the permeate produced from membrane distillation experiments was assessed in terms of conductivity using a Fisher Scientific Accumet XL200 conductivity meter. In addition, As³⁺ and As⁵⁺ was quantified using inductively coupled plasma mass spectroscopy (ICP-MS, Agilent 7700x) and Masshunter Version 5 software.

Membrane Distillation Tests

Arsenic removal experiments were performed using air gap membrane distillation. The system comprised of two isolated water loops—one containing tap water used for cooling the condenser plate inside the membrane module and one containing the heated feed water. The prepared synthetic solutions had concentrations of inorganic arsenic and sodium chloride similar to the concentrations of arsenic and conductivity recorded in water sources intended for human consumption in the rural area of the city of Tacna-Peru (Locumba River and Sama River). The feed water contained 600 ppb sodium arsenate dibasic heptahydrate and sufficient NaCl, to bring the feed conductivity up to 2500 μS cm⁻¹—similar to that of the Locumba river. A test was also conducted on the commercial PTFE membrane to see if the less harmful As³⁺ could be removed by AGMD. For this, 300 ppb of sodium meta arsenite was added instead of sodium arsenate dibasic heptahydrate.

After prior optimisation, the process conditions were selected as configuration: AGMD (air gap membrane distillation); air gap width: 3 mm; feed flow rate: 750 mL min⁻¹; feed temperature: 80° C.; coolant temperature: 20° C. The permeate samples were collected in a measuring cylinder after one hour of conditioning for each membrane. The flux was calculated by extrapolating the volume of permeate collected over 30 minutes, given a membrane area of 27.33 cm² and the salt rejection was calculated from permeate conductivity values, as described previously³². For the inorganic fouling experiments, the normalised flux was calculated using:

$$Normalised flux = \frac{J}{{J}_{0}} \qquad Equation 2$$

as the ratio of the flux at a particular time to the initial flux (measured after one hour of conditioning, as before).

Inorganic Fouling Experiments

In order to test the membranes' propensity for inorganic fouling, 10 mg L⁻¹ of calcium carbonate and 2 g L⁻¹ iron (Ill) sulphate heptahydrate were added to the same arsenic and sodium chloride feed solution used for prior experiments. This turned the water a terracotta colour. These contaminants, amongst others, are present in the water within the Tacna region of Peru and have been shown to cause significant fouling issues in various membrane applications^{19, 39-40}. In these experiments the mass of permeate was measured using a weighing scale (Adam Highland HCB 3001) connected to a data logger collecting one data point every two minutes in order to track any sudden changes in flux. Permeate was collected for three hours at the beginning and then was recirculated overnight and collected again for hours 22, 23 and 24 of the 24 hour experiment, during which time the loss of permeate resulted in the increased concentration of the feed—the aim being to reach saturation conditions. At each hour of permeate collection, a sample was taken for conductivity measurements and then returned to the collection vessel. All other process conditions were kept the same.

Results

Examples of the present invention were manufactured, using 0.5 wt %, 1 wt %, 2 wt % and 3 wt % of the POSS-rGO explained above. These were Examples 1 to 4 respectively.

For comparison, a membrane was manufactured in exactly the same way except 0 wt % of the POSS-rGO was included in the polymer mix for electrospinning. This is Comparative Example 1.

TABLE 1

| | Wt. % fGO filler | | POSS- | | |
|---|---|---|---|---|---|
| | in casting | PVDF | rGO | DMF | Acetone |
| Example | solution | (g) | (mg) | (g) | (g) |
| Comparative | 0 | 1.4 | 0 | 2.8667 | 5.733 |
| Example 1 | | | | | |
| Example 1 | 0.5 | 1.4 | 7 | 2.8597 | 5.733 |
| Example 2 | 1 | 1.4 | 14 | 2.8527 | 5.733 |
| Example 3 | 2 | 1.4 | 28 | 2.8387 | 5.733 |
| Example 4 | 3 | 1.4 | 42 | 2.8107 | 5.733 |

For further comparison, a commercially available PTFE membrane was tested and that is Reference Example 1.

For each of these membranes, their thickness, pore sizes (smallest pore size, mean pore size, largest pore size); porosities, nitrogen permeability, flux, permeate conductivity, salt rejection rate and permeate As⁵⁺ concentration were measured.

TABLE 2

| | | Content of | | | |
|---|---|---|---|---|---|
| | | POSS-rGO | Thickness | Pore size: smallest; | |
| Example | Polymer | (wt %) | (μm) | mean; largest (μm) | Porosity (%) |
| Reference | PTFE | 0 | 190 (±15) | 0.26 (±0.02); 0.26 | 80 (reported) |
| Example 1 | | | | (±0.01); 0.40 (±0.09) | |
| Comparative | PVDF | 0 | 89 (±10) | 5.69 (±0.03); 5.91 | 91.2 (±0.6) |
| Example 1 | | | | (±0.01); 7.48 (±0.25) | |
| Example 1 | PVDF | 0.5 | 68 (±29) | 4.06 (±0.16); 4.20 | 87.6 (±1.8) |
| | | | | (±0.19); 4.89 (±0.24) | |
| Example 2 | PVDF | 2 | 69 (±26) | 5.47 (±0.57); 5.65 | 87.8 (±0.4) |
| | | | | (±0.59); 6.47 (±0.54) | |
| Example 3 | PVDF | 2 | 70 (±14) | 9.37 (±0.62); 9.80 | 91.9 (±0.4) |
| | | | | (±0.73); 10.56 (±1.05) | |
| Example 4 | PVDF | 3 | 88 (±21) | 6.11 (±0.71); 6.34 | 89.9 (±0.9) |
| | | | | (±0.76); 7.25 (±0.08) | |

| | | | Permeate | |
|---|---|---|---|---|
| | N₂ | | conductivity | |
| | Permeability | Flux | (μS cm⁻¹)^{a}; Salt | Permeate As⁵⁺ |
| Example | (Barrer) | (L m⁻² h⁻¹)^{a} | rejection (%) | conc. (ppb)^{a, b} |
| Reference | 1.75 × 10⁸ | 14.15 (±2.12) | 1.8 (±0.2); >99.9 | <0.045 |
| Example 1 | (±3.50 × 10⁶) | | | <0.045^{d} |
| Comparative | 1.21 × 10⁹ | 22.99 (±1.06) | 1.1 (±0.1); >99.9 | <0.045 |
| Example 1 | (±8.57 × 10⁸) | | | |
| Example 1 | 1.15 × 10⁹ | 22.87 (±1.33) | 1.8 (±0.4); >99.9 | <0.045 |
| | (±1.54 × 10⁸) | | | |
| Example 2 | 2.02 × 10⁹ | 20.99 (±5.46) | 1.7 (±0.5); >99.9 | <0.045 |
| | (±4.36 × 10⁸) | | | |
| Example 3 | 2.82 × 10⁹ | 27.94 (±1.77) | 2.1 (±0.2) | <0.045 |
| | (±3.06 × 10⁸) | 28.30^{c} | 1.8^{c}; >99.9 | |
| Example 4 | 1.70 × 10⁹ | 16.98 (±0.00) | 2.0 (±0.1); >99.9 | <0.045 |
| | (±1.24 × 10⁸) | | | |

^{a}these values were measured after 24 hours of continuous testing;
^{b}0.045 ppb represents the detection limit of the ICPMS method;
^{c}these values were measured after 5 days of continuous testing;
^{d}this value corresponds to measured As³⁺ levels using feed water containing 300 ppb sodium meta arsenite, also below the detection limit indicating perfect rejection of As³⁺.

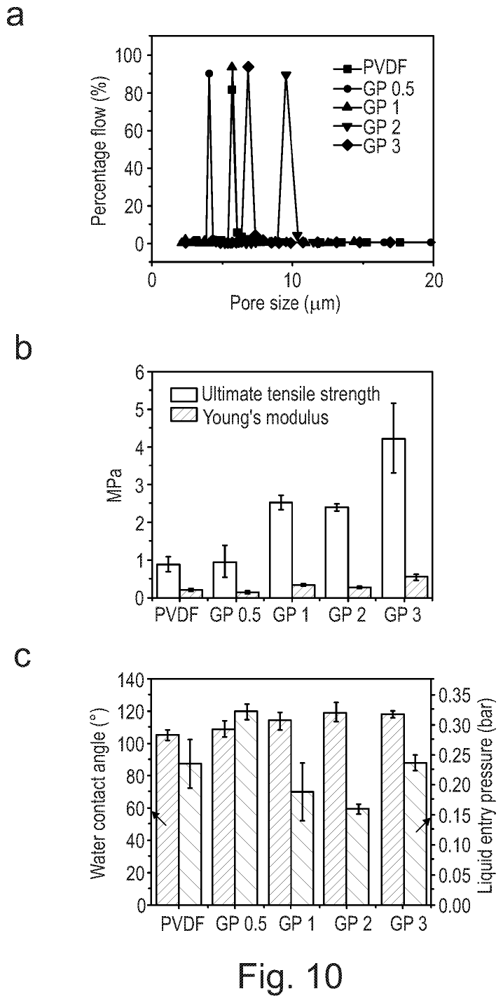

The mechanical properties of the membranes, as elucidated by tensile testing, were also tested. The results are presented in FIG. 10(b).

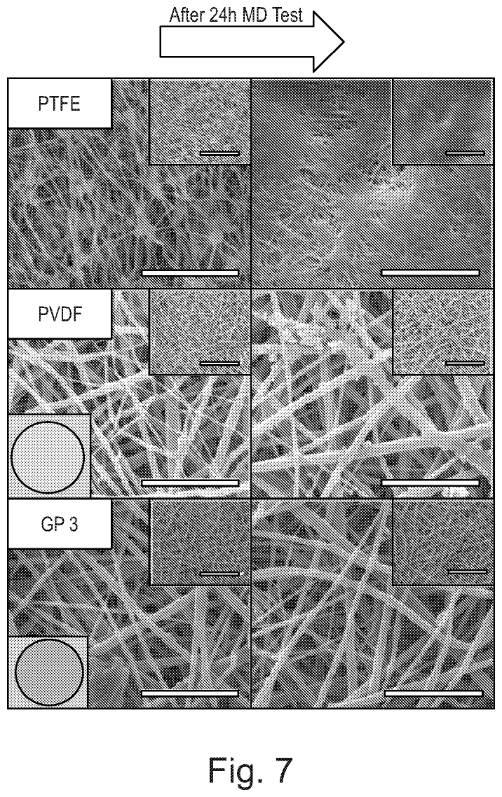

A positive trend was observed for both the ultimate tensile strength (UTS) and Young's modulus (YM) values as the loading of POSS-rGO increased. There was no significant difference between these values for the pure PVDF (Comparative Example 1) and GP 0.5 (Example 1), indicating a limited effect at such low loadings as 0.5 wt. %. However, at 2 wt. % (GP 2, Example 3)) the membrane exhibited a 38% increase in Young's modulus and a 271% increase in ultimate tensile strength compared to the pure polymer. This increased further for the membrane with a loading of 3 wt. % (GP 3, Example 4) which exhibited a 479% increase in UTS with a value of 4.22±0.92 Mpa and a 272% increase in YM compared to the pure polymer. These changes are likely due to the attractive interactions between the PVDF polymer chains and the branched alkyl groups extending from the silica core of the POSS molecule. In addition, the high surface area and high intrinsic strength of the graphene basal plane provides strong interfacial interaction with the polymer, increasing both the strength and stiffness of the membranes²²⁻²³. As seen from the SEM images, reproduced in FIG. 7, some graphene flakes are located at the intersections between multiple nanofibers. This is another advantage of using 2D graphene as opposed to 1D materials like carbon nanotubes²⁴, which may enhance the strength of individual fibres but not necessarily the interconnections between fibres. It is at these weak interconnections where mechanical failure is most likely to occur, prompting researchers to try and fuse them together with methods such as solvent vapour treatment²⁵. In this case however, the moderate hot-press treatment and the inclusion of POSS-rGO were sufficient to produce thin, highly porous yet robust membranes.

The wetting properties of the membranes were characterised by water contact angle measurements and liquid entry pressure (LEP) measurements. The results are presented in FIG. 10(c). The increased loading of POSS-rGO resulted in an increase in the water contact angle from 105±3° for pure PVDF to 119±6° for GP 2 (Example 3). This increase came despite the fact that the mean pore size of GP 2 (Example 3) was almost twice that of the PVDF membrane. Larger pore sizes tend to reduce the contact angle on hydrophobic surfaces such as PVDF as there is less material supporting the surface tension of the water droplet. In this case however, the addition of the highly hydrophobic POSS-rGO counteracted this tendency and resulted in larger pores and a higher contact angle. GP 3 (Example 4), despite having a higher loading of POSS-rGO and smaller mean pore size than GP 2 (Example 3), had approximately the same contact angle value of 118±2°.

The liquid entry pressure values do not follow the same trend as the water contact angle values but do relate to the maximum pore size values for the membranes. The membrane with the smallest LEP was GP 2 (Example 3) with a value of 0.159±0.007 bar. This membrane also had the largest maximum pore size value of 10.56±1.05 μm, more than twice that of GP 0.5 (Example 1) which had the largest LEP value of 0.321±0.013 μm. The remaining three membranes have very similar maximum pore size values and their LEP values lay within one standard deviation of each other, indicating the link between maximum pore size and liquid entry pressure. Intuitively, the largest pore in a membrane is the one which requires the least amount of pressure to force liquid through, all else being equal. It is important to note that these LEP values are considerably lower than that of the commercial PTFE (Reference Example 1) (3.683±1.677 bar). This is due to the high intrinsic hydrophobicity of PTFE compared to PVDF but also the significantly smaller maximum pore size value of 0.40 (±0.09) μm. These low LEP levels did not seem to affect the ability of these membranes to achieve high salt rejection in membrane distillation experiments, as the following section highlights.

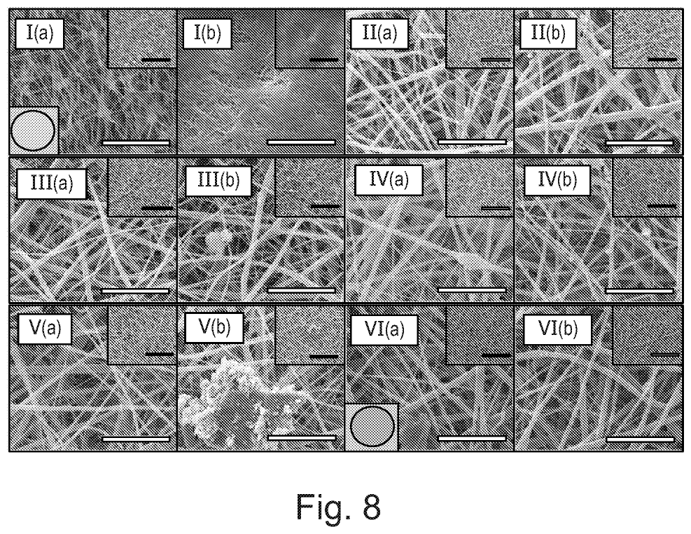

SEM imaging, shown in FIG. 7 and FIG. 8, demonstrates that the present membranes do not lose definition or porosity after membrane distillation experiments in the same way as commercial or unmodified membranes do. This is particularly apparent in comparison of I(a) and I(b) with, for example, III(a) and III(b).

These figures illustrate the difference between a commercial PTFE membrane and electrospun membranes (graphene-containing and PVDF alone). The larger pore size of the electrospun materials means when crystals form they tend to be too small to block the pores.

Capillary flow porometry revealed the present electrospun membranes to have surprisingly narrow pore size distributions; see FIG. 10(a). In all cases, over 85% of the total gas flow detected during the measurement corresponded to pores of mean size. When looking at the pore size range (i.e. the biggest minus the smallest) and dividing this by the mean pore size for each membrane, the values are 0.533, 0.305, 0.199, 0.177 and 0.179 for Reference Example 1, Comparative Example 1, Example 1, Example 2, Example 3 and Example 4, respectively. In other words, with respect to the mean pore size values, the distribution of pore sizes is narrower for the present electrospun membranes than the commercial PTFE membranes. This is an important property of MD membranes since large pore size distributions will contain many pores which are either too big (and so risk becoming wetted) or too small (and unnecessarily hindering vapour transport).

In addition to narrow pore size distributions, the present electrospun membranes have incredibly high porosities of around 90%. Table 2 summarises the porosity values as well as other characteristics of these membranes. In general, higher membrane porosity results in higher permeability and flux values as there is more free volume in which the permeating species can travel. Typical phase inversion membranes have porosities in the range of 70-80%. It is therefore very promising to be able to fabricate membranes with significantly higher porosities whilst retaining sufficient mechanical properties to withstand handling and high-shear testing environments. The highest porosity value belonged to GP 2 (Example 3) with a value of 91.9 (±0.4%) after hot-pressing. This is higher than most nanofiber membranes found in the literature, which typically suffer reductions in porosity to below 90% due to post-treatment²⁶⁻³⁰

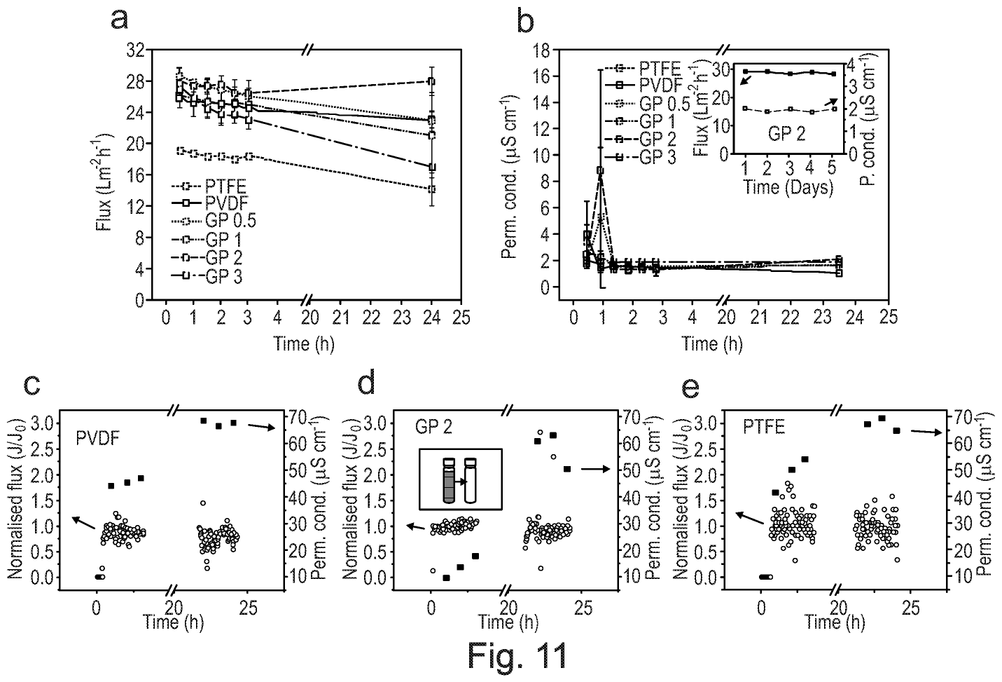

The flux and permeate conductivity values from the MD experiments are summarised in FIGS. 11(a) and (b). Most of the membranes show a similar flux pattern over 24 hours. A slight decline (<5%) in flux is observed over the first three hours for all membranes except Example 1 (GP 0.5) and Example 4 (GP 3) which showed declines of 9.1 and 15.1% respectively. This gradual decline continued over 24 hours of testing except in the case of Example 3 (GP 2), whose flux was stable at a value of 27.94±1.77 L m⁻² h⁻¹. This was 21.5% higher than Comparative Example 1 (the pure PVDF membrane) and nearly double that of Reference Example 1 (the commercial PTFE membrane) after the same time period.

This increased flux can be largely attributed to the increased hydrophobicity and larger mean pore size of this membrane compared to others.

The N₂ permeability for Example 3 (GP 2) was 57% higher than Comparative Example 1 (the pure PVDF membrane), despite their porosities being almost identical. Larger pore sizes are known to reduce the resistance to mass transfer in MD but increase the risk of pore wetting³¹. In this case, the high hydrophobicity of the membrane successfully prevented wetting despite its mean pore size value of 9.80±0.73 μm being 1-2 orders of magnitude larger than is typical for MD membranes.

It is possible that the membrane thickness affected the flux performance, particularly with respect to Reference Example 1 (the PTFE membrane) which was more than twice as thick as the Example electrospun membranes. However, the difference in thickness between the Example electrospun membranes is not particularly significant. Furthermore, previous work has suggested that the membrane thickness plays a much less significant role in increasing the mass transfer resistance compared to the air gap, which is orders of magnitude thicker³²⁻³⁴.

In order to further test the flux stability of Example 3 (GP 2), a five-day continuous MD experiment was conducted, yielding a final flux value of 28.30 L m⁻² h⁻¹ and a corresponding permeate conductivity value of 1.786 μS cm⁻¹. This is evidence of the high stability of the separation process for this type of feed solution.

In general, all Example electrospun membranes produced very high quality permeate with conductivities of less than 2 μS cm⁻¹. This corresponds to very high salt rejection values of >99.9%. The arsenic levels in the permeate for all membranes were below the detection limit of the ICP-MS (<0.045 ppb). This means that all samples produced water of significantly higher quality than recommended by the WHO (<10 ppb).

In order to test the membranes under fouling conditions, 10 mg V of calcium carbonate and 2 g V iron sulphate heptahydrate were added to the feed solution to create near-saturation conditions. Upon dissolving, the ions will dissociate and recombine to form precipitates once the saturation limit has been reached. Two well-known inorganic foulants in membrane distillation are calcium sulphate and calcium carbonate as they become less soluble at higher temperatures. Previous studies have shown that these crystals can form on the membrane surface, eventually leading to pore blocking and flux decline^{18, 35}. The normalised flux values for Comparative Example 1 (the pure PVDF), Example 3 (GP 2) and Reference Example 1 (commercial PTFE membrane) were plotted as a function of time to assess the flux stability in these harsh conditions.

As can be seen in FIGS. 11(c)-(e), the flux values were fairly stable throughout the 24 hour experiments for both the present Example electrospun membranes and Reference Example 1, although Reference Example 1 (the PTFE membrane) exhibited greater fluctuations throughout the test. There is a noticeable difference in the permeate conductivity for the first three hours of testing for Example 3 (GP 2), which was considerably lower than for Comparative Example 1 (pure PVDF) and Reference Example 1 (PTFE) membranes (9-20 μS cm⁻¹ compared with 40-60 μS cm⁻¹).

However, after 24 hours of testing, the permeate conductivities increased for all membranes to between 60 and 70 μS cm⁻¹ for Comparative Example 1 (PVDF) and Reference Example 1 (PTFE) and 50-63 μS cm⁻¹ for Example 3 (GP 2), owing to the very high solute concentration resulting in partial wetting, which in turn enabled transport of inorganic solutes across the membrane. This lower permeate conductivity for the Example 3 (GP 2) membrane suggests it had slightly better wetting resistance than the other two membranes but in all cases, the permeate quality is still very high, and well within the range for safe drinking.

During periods where the permeate was externally collected rather than recirculated, the feed water became more concentrated to the point where crystals were clearly visible in the water and on the surfaces of the feed vessel and tubing. (This precipitation away from the membrane surface may explain the relatively stable flux values observed in these experiments.) Once precipitation was initiated in the vessel, subsequent precipitation and crystal growth was favoured there rather than on the membrane surface. This phenomenon has been reported before 36. Despite this, at the end of the experiments, the membranes were removed and though thoroughly rinsed in DI water and still had visible coloration from the feed water, suggesting some precipitation did indeed occur on the membrane surface. This is further evidenced by the observed increases in permeate conductivity and the EDX data depicted in FIG. 9. Pronounced peaks are observed for carbon and fluorine from all three membranes, as expected given their chemical makeup. In addition, the elements Fe and O are also prominent in the EDX spectra and overlap in the element maps. This is suggestive of iron oxides precipitating on the membrane, which are responsible for the red/brown colour of the feed solution. The spectrum for Example 3 (GP 2) shows the presence of silicon which originates from the POSS functional group on the graphene. Trace amounts of silicon detected on Reference Example 1 (PTFE) are likely due to contamination and similarly, trace amounts of copper present in the electrospun membranes may be the result of contamination from the stainless steel collector plate on which the membranes were formed. Small peaks corresponding to sulphur are present on the electrospun membranes, again suggesting some precipitation of sulphate crystals on the membrane, although this peak is missing for Reference Example 1 (PTFE), suggesting that precipitation occurred preferentially away from the membrane surface. Furthermore, the absence of calcium peaks from all spectra indicates that no CaCO₃ crystals precipitated on the membrane but instead remained in the vessel or tubing. The presence of platinum is a result the membrane coating process during the sample preparation.

In the case of the present electrospun membranes, the crystals that did precipitate on their surfaces did not grow sufficiently large to completely cover the pores, whereas Reference Example 1 (PTFE) has a much more densely coated surface. This may be the reason why the normalised flux values were much less stable for Reference Example 1 (PTFE).

### DISCUSSION

Air gap membrane distillation experiments showed perfect rejection of arsenic from simulated ground water of the Tacna region, Peru. High performance electrospun PVDF membranes were enhanced in terms of mechanical properties, hydrophobicity and membrane distillation performance with the addition of POSS-functionalised graphene. The most preferred loading was 2 wt. % with respect to the polymer which resulted in a 280% increase in the ultimate tensile strength compared to the pure PVDF membrane. This membrane (Example 3) demonstrated a stable flux of −28 L m⁻² h⁻¹ over 5 days of continuous testing while the pure PVDF membrane (Comparative Example 1) showed 10.9% flux decline over just 24 hours. This most preferred membrane had nearly twice the flux of a commercial PTFE membrane but all membranes in all cases showed very high (>99.9%) rejection of salt, highlighting the effectiveness of air gap membrane distillation at removing inorganic contaminants. These membranes also performed well when treating a highly concentrated solution containing calcium carbonate, iron sulphate, sodium chloride and sodium arsenate dibasic heptahydrate. The POSS-rGO membrane (Examples 1-4) demonstrated more stable flux over 24 hours of testing compared to the pure PVDF (Comparative Example 1) membrane and also higher rejection values. Fouling with iron oxides was evident from EDX measurements (see FIG. 9) but seemed more prominent on the commercial PTFE membrane (Reference Example 1) due to the crystal size being comparable to or than the pore size. The much larger pore sizes of the electrospun membranes meant that they were not blocked or covered by the foulant crystals. Minimal amounts on sulphur and no traces of calcium were found from the EDX measurements, which suggests that AGMD may be a suitable technology for zero liquid discharge applications. In the case of treating arsenic-contaminated groundwater, this approach is necessary in order to prevent further environmental damage.

It is noted that the GP 2 membrane (Example 3) shows a pronounced Si peak, indicative of the POSS-rGO loading. In the elemental map there are Si clusters concentrated on the surface of graphene flakes, as highlighted by dashed circles. This is further evidence of successful grafting of POSS molecules onto the graphene as well as successful incorporation of POSS-rGO into the electrospun membranes.

### REFERENCES

A number of publications are cited above in order to more fully describe and disclose the invention and the state of the art to which the invention pertains. Full citations for these references are provided below.

The entirety of each of these references is incorporated herein.
1. Chakraborti, D.; Singh, S.; Rahman, M.; Dutta, R.; Mukherjee, S.; Pati, S.; Kar, P., Groundwater arsenic contamination in the Ganga River Basin: a future health danger. International journal of environmental research and public health 2018, 15 (2), 180.
2. de Meyer, C.; Rodriguez, J.; Carpio, E.; Garcia, P.; Wahnfried, I.; Roeser, P.; Kipfer, R.; Berg, M. In Arsenic contamination of groundwater resources in the Amazon Basin: An emerging health concern?, EGU General Assembly Conference Abstracts, 2018; p 9895.
3. Sanjrani, M.; Zhou, B.; Zhao, H.; Bhutto, S.; Muneer, A.; Xia, S., ARSENIC CONTAMINATED GROUNDWATER IN CHINA AND ITS TREATMENT OPTIONS, A REVIEW. APPLIED ECOLOGY AND ENVIRONMENTAL RESEARCH 2019, 17 (2), 1655-1683.
4. Organization, W. H., Exposure to arsenic: a major public health concern. Geneva: Public Health and Environment 2010, 1.
5. Gomez-Caminero, A.; Howe, P. D.; Hughes, M.; Kenyon, E.; Lewis, D.; Moore, M.; Aitio, A.; Becking, G. C.; Ng, J., Arsenic and arsenic compounds. 2001.
6. Lawson, K. W.; Lloyd, D. R., Membrane distillation. Journal of membrane Science 1997, 124 (1), 1-25.
7. Criscuoli, A.; Zhong, J.; Figoli, A.; Carnevale, M.; Huang, R.; Drioli, E., Treatment of dye solutions by vacuum membrane distillation. Water research 2008, 42 (20), 5031-5037.
8. Mericq, J.-P.; Laborie, S.; Cabassud, C., Vacuum membrane distillation of seawater reverse osmosis brines. Water Research 2010, 44 (18), 5260-5273.
9. Kim, J.; Kim, J.; Hong, S., Recovery of water and minerals from shale gas produced water by membrane distillation crystallization. Water research 2018, 129, 447-459.
10. Wang, Z.; Lin, S., Membrane fouling and wetting in membrane distillation and their mitigation by novel membranes with special wettability. Water research 2017, 112, 38-47.
11. Lee, J.; Boo, C.; Ryu, W.-H.; Taylor, A. D.; Elimelech, M., Development of omniphobic desalination membranes using a charged electrospun nanofiber scaffold. ACS applied materials & interfaces 2016, 8 (17), 11154-11161.
12. Vasita, R.; Katti, D. S., Nanofibers and their applications in tissue engineering. International Journal of nanomedicine 2006, 1 (1), 15.
13. Zhu, Y.; Han, X.; Xu, Y.; Liu, Y.; Zheng, S.; Xu, K.; Hu, L.; Wang, C., Electrospun Sb/C fibers for a stable and fast sodium-ion battery anode. ACS nano 2013, 7 (7), 6378-6386.
14. Zhang, R.; Liu, C.; Hsu, P.-C.; Zhang, C.; Liu, N.; Zhang, J.; Lee, H. R.; Lu, Y.; Qiu, Y.; Chu, S., Nanofiber air filters with high-temperature stability for efficient PM2. 5 removal from the pollution sources. Nano letters 2016, 16 (6), 3642-3649.
15. El-Newehy, M. H.; El-Nagger, M. E.; Alotaiby, S.; El-Hamshary, H.; Moydeen, M.; Al-Deyab, S., Green electrospinning of hydroxypropyl cellulose nanofibres for drug delivery applications. Journal of nanoscience and nanotechnology 2018, 18 (2), 805-814.
16. Moran-Mirabal, J. M.; Slinker, J. D.; DeFranco, J. A.; Verbridge, S. S.; Ilic, R.; Flores-Torres, S.; Abruña, H.; Malliaras, G. G.; Craighead, H., Electrospun light-emitting nanofibers. Nano letters 2007, 7 (2), 458-463.
17. Wang, X.; Yang, B.; Liu, J.; Zhu, Y.; Yang, C.; He, Q., A flexible triboelectric-piezoelectric hybrid nanogenerator based on P (VDF-TrFE) nanofibers and PDMS/MWCNT for wearable devices. Scientific reports 2016, 6, 36409.
18. Gryta, M., Calcium sulphate scaling in membrane distillation process. Chemical Papers 2009, 63 (2), 146-151.
19. Gryta, M., Effect of iron oxides scaling on the MD process performance. Desalination 2007, 216 (1-3), 88-102.
20. Abdel-Karim, A.; Leaper, S.; Alberto, M.; Vijayaraghavan, A.; Fan, X.; Holmes, S. M.; Souaya, E. R.; Badawy, M. I.; Gorgojo, P., High flux and fouling resistant flat sheet polyethersulfone membranes incorporated with graphene oxide for ultrafiltration applications. Chemical Engineering Journal 2018, 334, 789-799.
21. Xue, Y.; Liu, Y.; Lu, F.; Qu, J.; Chen, H.; Dai, L., Functionalization of graphene oxide with polyhedral oligomeric silsesquioxane (POSS) for multifunctional applications. The journal of physical chemistry letters 2012, 3 (12), 1607-1612.
22. Liao, W.-H.; Yang, S.-Y.; Hsiao, S.-T.; Wang, Y.-S.; Li, S.-M.; Ma, C.-C. M.; Tien, H.-W.; Zeng, S.-J., Effect of octa (aminophenyl) polyhedral oligomeric silsesquioxane functionalized graphene oxide on the mechanical and dielectric properties of polyimide composites. ACS applied materials & interfaces 2014, 6 (18), 15802-15812.
23. Xue, Y.; Wang, H.; Yu, D.; Feng, L.; Dai, L.; Wang, X.; Lin, T., Superhydrophobic electrospun POSS-PMMA copolymer fibres with highly ordered nanofibrillar and surface structures. Chemical communications 2009, (42), 6418-6420.
24. Sen, R.; Zhao, B.; Perea, D.; ltkis, M. E.; Hu, H.; Love, J.; Bekyarova, E.; Haddon, R. C., Preparation of single-walled carbon nanotube reinforced polystyrene and polyurethane nanofibers and membranes by electrospinning. Nano letters 2004, 4 (3), 459-464.
25. Huang, L.; Manickam, S. S.; McCutcheon, J. R., Increasing strength of electrospun nanofiber membranes for water filtration using solvent vapor. Journal of membrane science 2013, 436, 213-220.
26. An, A. K.; Guo, J.; Lee, E.-J.; Jeong, S.; Zhao, Y.; Wang, Z.; Leiknes, T., PDMS/PVDF hybrid electrospun membrane with superhydrophobic property and drop impact dynamics for dyeing wastewater treatment using membrane distillation. Journal of Membrane Science 2017, 525, 57-67.
27. Lalia, B. S.; Guillen-Burrieza, E.; Arafat, H. A.; Hashaikeh, R., Fabrication and characterization of polyvinylidenefluoride-co-hexafluoropropylene (PVDF-HFP) electrospun membranes for direct contact membrane distillation. Journal of membrane science 2013, 428, 104-115.
28. Li, X.; Yu, X.; Cheng, C.; Deng, L.; Wang, M.; Wang, X., Electrospun superhydrophobic organic/inorganic composite nanofibrous membranes for membrane distillation. ACS applied materials & interfaces 2015, 7 (39), 21919-21930.
29. Liao, Y.; Loh, C.-H.; Wang, R.; Fane, A. G., Electrospun superhydrophobic membranes with unique structures for membrane distillation. ACS applied materials & interfaces 2014, 6 (18), 16035-16048.
30. Li, X.; Wang, C.; Yang, Y.; Wang, X.; Zhu, M.; Hsiao, B. S., Dual-biomimetic superhydrophobic electrospun polystyrene nanofibrous membranes for membrane distillation. ACS applied materials & interfaces 2014, 6 (4), 2423-2430.
31. Wang, P.; Teoh, M. M.; Chung, T.-S., Morphological architecture of dual-layer hollow fiber for membrane distillation with higher desalination performance. water research 2011, 45 (17), 5489-5500.
32. Abdel-Karim, A.; Luque-Alled, J. M.; Leaper, S.; Alberto, M.; Fan, X.; Vijayaraghavan, A.; Gad-Allah, T. A.; El-Kalliny, A. S.; Szekely, G.; Ahmed, S. I., PVDF membranes containing reduced graphene oxide: Effect of degree of reduction on membrane distillation performance. Desalination 2019, 452, 196-207.
33. El-Bourawi, M.; Ding, Z.; Ma, R.; Khayet, M., A framework for better understanding membrane distillation separation process. Journal of membrane science 2006, 285 (1-2), 4-29.
34. Lagana, F.; Barbieri, G.; Drioli, E., Direct contact membrane distillation: modelling and concentration experiments. Journal of Membrane Science 2000, 166 (1), 1-11.
35. He, F.; Sirkar, K. K.; Gilron, J., Studies on scaling of membranes in desalination by direct contact membrane distillation: CaCO₃ and mixed CaCO₃/CaSO4 systems. Chemical Engineering Science 2009, 64 (8), 1844-1859.
36. Tijing, L. D.; Woo, Y. C.; Choi, J.-S.; Lee, S.; Kim, S.-H.; Shon, H. K., Fouling and its control in membrane distillation—A review. Journal of Membrane Science 2015, 475, 215-244.
37. Leaper, S.; Abdel-Karim, A.; Faki, B.; Luque-Alled, J. M.; Alberto, M.; Vijayaraghavan, A.; Holmes, S. M.; Szekely, G.; Badawy, M. I.; Shokri, N., Flux-enhanced PVDF mixed matrix membranes incorporating APTS-functionalized graphene oxide for membrane distillation. Journal of Membrane Science 2018, 554, 309-323.
38. Leaper, S.; Abdel-Karim, A.; Gad-Allah, T. A.; Gorgojo, P., Air-gap membrane distillation as a one-step process for textile wastewater treatment. Chemical Engineering Journal 2018.
39. Gryta, M., Water desalination by membrane distillation. Desalination, Trends and Technologies 2011, 21-40.
40. Kavitskaya, A.; Knyazkova, T.; Maynarovich, A., Reverse osmosis of concentrated calcium sulphate solutions in the presence of iron (Ill) ions using composite membranes. Desalination 2000, 132 (1-3), 281-286.

What is claimed:

1. A membrane for use in membrane distillation, comprising a porous polymer matrix and functionalized graphene or graphene oxide,
the graphene or graphene oxide being functionalized with a polyhedral oligomeric silsesquioxane.

2. A membrane according to claim 1, wherein the membrane comprises about 0.2 to 5 wt % of the functionalised graphene or graphene oxide, preferably about 0.5 to 3 wt % or about 1 to 3 wt %, more preferably about 2 wt %.

3. A membrane according to claim 1, which is obtainable by a nonsolvent-induced phase separation method, electrospinning, solution blow spinning, electro-blow spinning or centrifugal spinning.

4. A membrane according to claim 1, wherein the polymer comprises polyvinylidene fluoride.

5. A membrane according to claim 1, wherein the polyhedral oligomeric silsesquioxane is represented by the following formula: 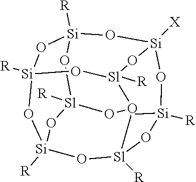
wherein each R and X is independently selected from H, alkyl, fluoroalkyl, aryl, fluoroaryl, alkoxyl, fluoroalkoxyl, silyl ether and fluorosilyl ether, each being optionally substituted with one or more —OH groups, and wherein at least one R or X group is not H and comprises a bond to the graphene or graphene oxide.

6. A membrane according to claim 5, wherein each R is (CH₂)(CH)(CH₃)₂ and X is (CH₂)₃NH—, where — represents the bond to the graphene or graphene oxide; or wherein each R is O—Si(CH₃)₂—(CH₂)₂—C(CH₃)₂—OH and X is O—Si(CH₃)₂—(CH₂)₂—C(CH₃)₂—O—.

7. A membrane according to claim 1, having a porosity of 60-95%.

8. A membrane distillation module, comprising a permeate side conduit; a feed side conduit; and a membrane according to claim 1 between the permeate side conduit and the feed side conduit.
